(19) United States
(12) Patent Application Publication
(10) Pub. No.: US 2015/0355725 A1
(43) Pub. Date: Dec. 10, 2015

(54) Input Device

(71) Applicant: Nokia Technologies Oy, Espoo (FI)

(72) Inventors: Zhigang Chen, Beijing (CN); Yong Li, Beijing (CN); Zheng Xia, Beijing (CN); Ligang Shang, Beijing (CN)

(21) Appl. No.: 14/760,501

(22) PCT Filed: Jan. 15, 2013
(86) PCT No.: PCT/CN2013/070482

§ 371 Date: Jul. 13, 2015

(51) Int. Cl. G06F 3/02; C23C 18/16; G06F 3/023

(52) U.S. Cl. CPC G06F 3/0227; G06F 3/023; G06F 3/0202; C23C 18/1633

(57) ABSTRACT

In accordance with an example embodiment of the present invention, an apparatus is disclosed with: a touch surface having one or more key tops configured to identify one or more keys to a user; a key sensing circuitry configured to detect a key press of any one or more of the key tops; a network of electromagnetic touch detectors configured to continually detect touching of the touch surface; and an elastic layer between the key sensing circuitry and the key tops configured to relay pressing forces from the key tops to the key sensing circuitry.

### TECHNICAL FIELD

The present application generally relates to an input device.

### BACKGROUND

Touchscreens have become very common as they enable very simple and intuitive pointing operations, for example. However, touchscreens have some disadvantages such as that for touching a given part of the touchscreen, the user has to partly obscure the touchscreen with her finger. The touching also tends to smear the surface of the touchscreen so that increased brightness may be needed with the associated cost at battery life. Moreover, actual keys are generally more convenient for typing as they usually provide a clear tactile response with a key depressed issuing a sudden decrease in the key force, click action, coinciding with reading of a key press.

Sometimes, touchscreens and keypads are combined by arranging a keypad near a touchscreen. Thus, best of both worlds can be combined, although the issues with touchscreens still remain.

### SUMMARY

Various aspects of examples of the invention are set out in the claims.

According to a first example aspect of the present invention, there is provided an apparatus comprising:

a touch surface comprising one or more key tops configured to identify one or more keys to a user;

a key sensing circuitry configured to detect a key press of any one or more of the key tops;

a network of electromagnetic touch detectors configured to continually detect touching of the touch surface; and

an elastic layer between the key sensing circuitry and the key tops configured to relay pressing forces from the key tops to the key sensing circuitry.

According to a second example aspect of the present invention, there is provided a device comprising a display; and the apparatus of the first example aspect.

According to a third example aspect of the present invention, there is provided a method comprising:

forming a touch surface comprising one or more key tops configured to identify one or more keys to a user;

forming a key sensing circuitry configured to detect a key press of any one or more of the key tops;

forming a network of electromagnetic touch detectors configured to continually detect touching of the touch surface; and

forming an elastic layer between the key sensing circuitry and the key tops configured to relay pressing forces from the key tops to the key sensing circuitry.

The network of electromagnetic detectors may be formed by selective activation plating.

The network of electromagnetic detectors may be formed by super energy beam induced deposition.

The network of electromagnetic detectors may be formed onto a separate layer. Alternatively, the network of electromagnetic detectors may be formed onto a rear surface of an exterior layer that forms the key tops and; or onto the elastic layer.

### BRIEF DESCRIPTION OF THE DRAWINGS

For a more complete understanding of example embodiments of the present invention, reference is now made to the following descriptions taken in connection with the accompanying drawings in which:

FIG. 1 shows an apparatus according to an example embodiment of the invention;

FIG. 2 shows a perspective drawing of an example of some components with which a combined touch detection and key detection can be provided;

FIG. 3 shows the components of FIG. 2 when assembled;

FIG. 4 illustrates a section view of some parts of an apparatus that comprises a combined touch detection and key press detection;

FIG. 5 shows a process for forming electromagnetic detectors for the apparatus of FIG. 1 according to one example embodiment;

FIG. 6 shows a section of some components of an apparatus according to an example embodiment; and

FIG. 7 shows a key detection circuitry according to an example embodiment.

### DETAILED DESCRIPTON OF THE DRAWINGS

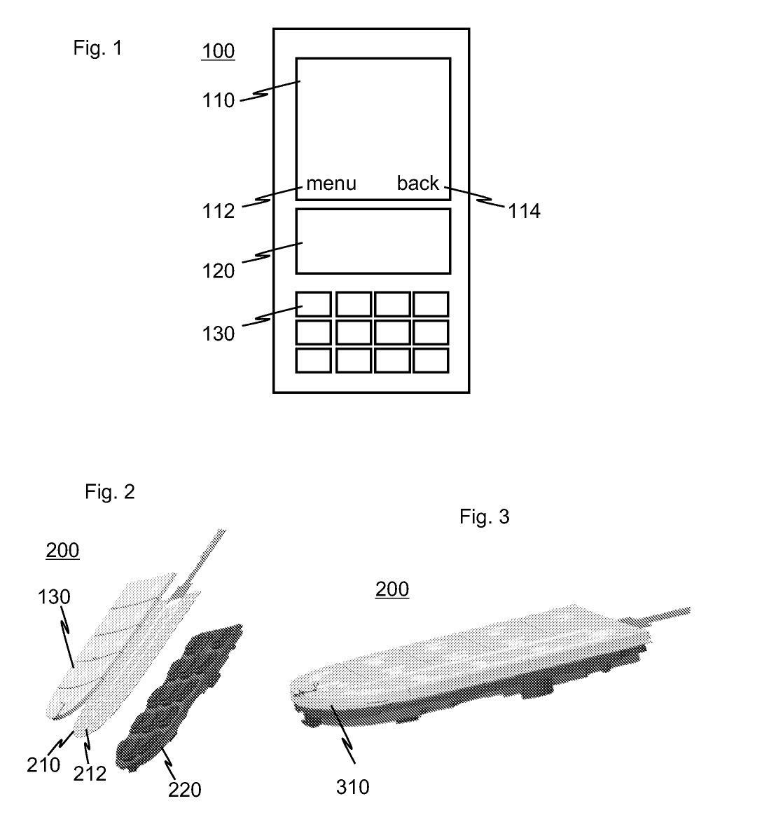

An example embodiment of the present invention and its potential advantages are understood by referring to FIGS. 1 through 7 of the drawings.

FIG. 1 shows an apparatus 100 according to an example embodiment of the invention. The apparatus 100 of this example is a portable device such as a mobile telephone; navigation device; game console; electronic book; a laptop computer; and/or personal digital assistant. The apparatus 100 comprises a display 110 such as a liquid crystal display; an organic light emitting diode display; or an electric ink display. The display can be configured to display any graphics and text, with two soft key legends 112 and 114 shown near one edge of the display 110 for an example. Next to the display or adjacent to the display 110 a touch control surface 120 is provided for use e.g. as known from touch pads. Additionally, the touch control surface 120 can be used to implement one or more soft keys so that on touching a region of the touch control surface 120 next to a soft key legend 112, 114, a corresponding action is taken. The apparatus 100 further comprises one or more keys 130 e.g. in the form of a keypad or keyboard.

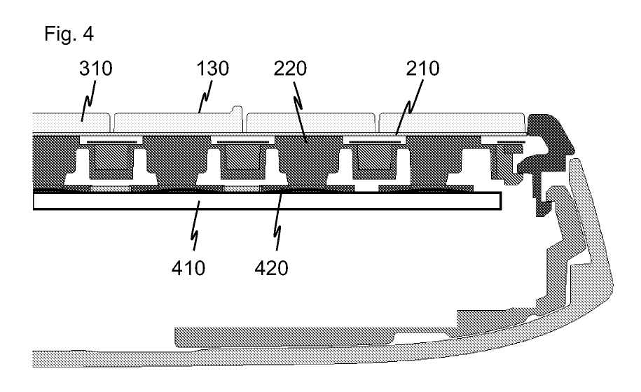

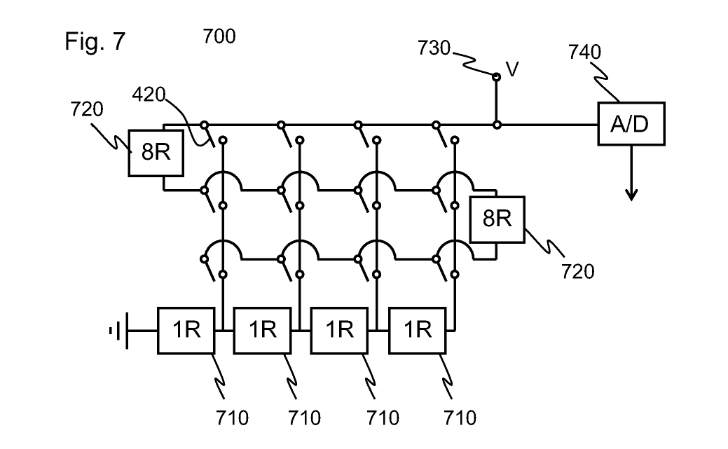

The keys 130 together form a touch surface on which a user can hover or slide her finger e.g. for controlling the apparatus 100. In embodiments with the touch control surface 120, the touch control surface 120 and the touch surface of the keys 130 can be used together as one large touch area through which user input may be read by touch detection while the keys 130 can still be used as normal keys. FIG. 2 illustrates an example of some components with which a combined touch detection and key detection can be provided. FIG. 3 shows the components of FIG. 2 when assembled. The keys 130 together form an exterior layer 310 behind which there is a sensing layer 210 carrying key sensing layer that has a network of electromagnetic detectors 212 e.g. as printed antennas. The exterior layer 310 is in an example embodiment 0.5 mm to 1.5 mm or more thick. The sensing layer 210 is e.g. 0.1 to 1 mm thick. In one example embodiment, the sensing layer 210 is 0.15 mm to 0.3 mm thick. Further behind the sensing layer 210 there is shown a rubber layer (e.g. of natural or synthetic rubber or thermoplastic polyurethane) 220 that is configured to act as an elastic layer that relies on key presses to underlying key sensing circuitry (see FIG. 4 for domes 420 and FIG. 7 for an example of a key sensing circuitry).

FIG. 4 illustrates a section view of some parts of an apparatus that comprises a combined touch detection and key press detection. The sensing layer 210 is located immediately behind the keys 130 (or touch surface or touch layer) so that a finger tip or stylus touching the touch surface or top of the keys 130 can be detected e.g. with capacitive sensing. On the other hand, if a key 130 is pressed, the key press is relayed through the sensing layer 210 and the rubber layer 220 to the key sensing circuitry (e.g. key dome 420). With the rubber layer 220 in between, the tactile response can be made more convenient and clicking sound be somewhat reduced. Moreover, the rubber layer 220 provides a degree of softness and voids at borders between keys so that the touch sensing layer 210 can flex with larger radius than if being placed directly between the keys 130 and the key domes 420. Moreover, the rubber layer 220 can be configured to reduce mechanical shocks and thus extend lifetime of the key sensing circuitry.

The key tops 130 on the touch surface are configured in one example embodiment to identify one or more keys to a user. The key tops can be formed of a single sheet of plastic for example or discrete parts. If formed of a single sheet, then the different keys can be identified by a suitable pattern, for example. With discrete parts, the boundaries or borders of the key tops form the identification.

The key sensing circuitry is in one example embodiment a matrix of signal lines that cross at each dome and the key press is determined by detecting which signal lines become connected together on pressing a key. In another example embodiment, each key has an independent connection that enables simultaneous detection of pressing of two or more keys. An example of a key detection circuitry will be described in the following with reference to FIG. 7. In an alternative embodiment the key sensing circuitry can comprise two or more conductive tracks that may be shorted together to indicate the presence of a physical touch. In yet another example embodiment, the key sensing circuitry comprises a surface acoustic wave sensor. Various known techniques can be used for the key sensing and thus this part is not explained any further.

The operation of touch sensors as such is known and thus needs no detailed description. However, FIG. 2 illustrates the electromagnetic detectors 212 around each key. This arrangement is provided to illustrate one example embodiment in which connectors are deliberately formed between contacting portions of the key tops and the electromagnetic detectors 212. With the rubber layer 220 having protrusions aligned with the keys, there are gaps between the protrusions where the electromagnetic detectors 212 are not likely to be abraded when the keys are being pressed. The electromagnetic detectors 212 are yet so aligned and monitored that a touch at any key or region between any keys is detected by an assigned touch detector (not shown). In one example embodiment, the electromagnetic detectors 212 are arranged in a grid that is not necessarily aligned with the key tops.

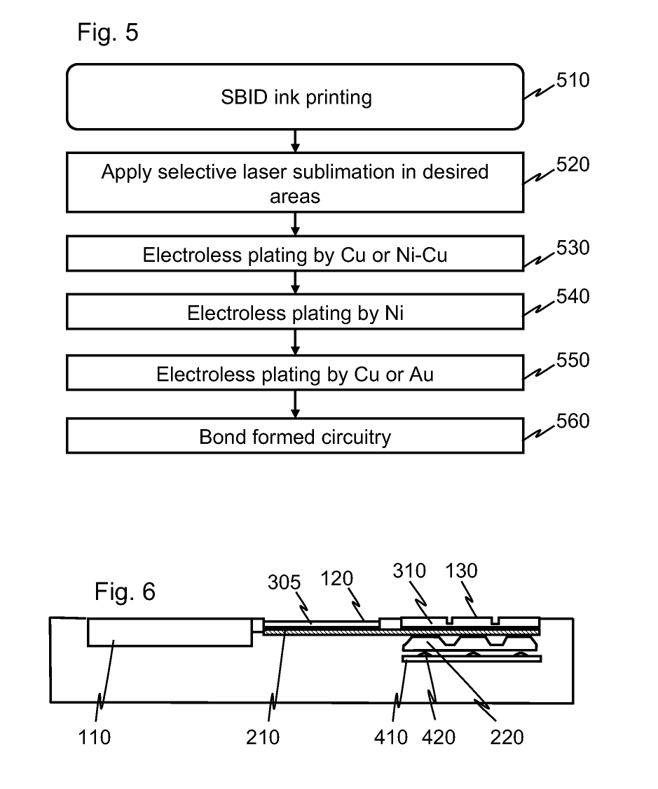

In one example embodiment, selective activation plating is used for forming the electromagnetic detectors 212. In broad terms, energy beams can be used to sublimate selectively plastics areas so as to expose particular nano-size particles encapsulated in a polymer matrix of the plastics. This can efficiently promote electroless plating so that only the selected area can be plated. For instance, super energy beam induced deposition (SBID) is used in forming the electromagnetic detectors 212 to the touch sensing layer 210 as shown in FIG. 5. In step 510, sheet material (e.g. a plastic film) is first printed with a suitable SBID ink. Following the printing, laser sublimation 520 is selectively applied in desired areas. Then, electroless plating 530 by Cu,Ni—Cu is performed, an electroless plating 540 by Ni is performed and an electroless plating 550 by Cu or Au is performed. The formed circuitry is then bonded 560 to the touch sensing layer 210. The bonding is made in one example embodiment with a bond flexible printed circuit (FPC) for connecting to a printed wire board (PWB) e.g. using thermo-sensitive adhesive In the SBID, a pattern can be formed on substrate that comprises e.g. polycarbonate (PC) and/or polycarbonate-acrylonitrile butadiene styrene (PC-ABS) with active particles. Sublimation part of the SBID can be made by laser etching.

FIG. 6 shows a section of some components of an apparatus according to an example embodiment, such as the apparatus 100 of FIG. 1. FIG. 6 also exemplifies an embodiment in which the touch sensing layer 210 extends beyond the touch surface formed by the keys 130 to sense touching at the touch control surface 120. In other words, the touch surface has a first region and a second region non-overlapping the first region; and the key tops are solely comprised by the first region.

FIG. 6 also shows another layer such as a plastic film 305 covering the touch sensing layer 210 at the touch control surface 120. In another example embodiment (not shown), there is no separate layer covering the touch sensing layer 210 at the touch control surface. Instead, the touch sensing layer 210 can be uncovered at this region. For protection against scratching, a lacquer treatment or painting is applied at this region in one example embodiment.

FIG. 6 also shows a sectional view of an exterior layer 310 comprising a first side configured to form the touch surface. The exterior layer 310 is e.g. formed of a single layer e.g. of plastic material. The plastic material can be flexible such as polyethylene (high density), polypropylene, polyurethane, synthetic rubber, nylon, ethylene vinyl acetate, polyvinyl chloride, and/or thermoplastic elastomer. Alternatively, the exterior layer 310 can be formed of rigid material such as non-flexible plastic material or metal with flexible connections allowing a degree of deforming in the exterior layer. In an example embodiment, the touch sensing layer 210 is resiliently biased with the elastic layer against the exterior layer 310 such that on pressing one of the one or more key tops, the movement of the touch sensing layer 210 is greater with respect to the pressed key top. When the touch sensing layer 210 can move over a greater area than the key top above, the touch sensing layer 210 can be made of less flexible materials and/or tensions incurred in the touch sensing layer 210 be reduced.

While FIG. 6 shows separate layers for the key press detection, touch detection and for the key tops as well as the rubber layer 220, some example embodiments combine layers together. For instance, in one example embodiment, the electromagnetic detectors are formed on rear side of the exterior layer 310 that forms the key tops. In another example embodiment, the electromagnetic detectors are instead formed onto the rubber layer 220, on a side that is nearer to the exterior layer 310.

FIG. 7 shows a key detection circuitry 700 according to an example embodiment. The key detection circuitry is configured to form varying resistance between a voltage supply node 720 and ground using suitably connected and dimensioned resistors 710, 720. When a key is pressed, a corresponding dome 420 connects lines crossing at the dome thus forming paths of individual resistance to the ground so that the voltage at the voltage supply indicates the key that is being pressed. With suitable connection, two or more simultaneously pressed keys can also be detected. As a detector, the key detection circuitry 700 comprises an analogue to digital converter 740.

Without in any way limiting the scope, interpretation, or application of the claims appearing below, a technical effect of one or more of the example embodiments disclosed herein is that touch detection can be combined with key press detection with simple and reliable equipment. Another technical effect of one or more of the example embodiments disclosed herein is that the equipment for combined touch and key press detection can be made very thin. Another technical effect of one or more of the example embodiments disclosed herein is that electromagnetic touch detectors can be located immediately behind the key tops. This can further enhance reliability of the touch detection. Yet another technical effect of one or more of the example embodiments disclosed herein is that the locating of the electromagnetic touch detectors immediately behind the key tops can enable lowering power of the electromagnetic touch detectors and thus reduce internal interference on other components and power consumption. The reducing internal interference can further reduce need for internal shielding. In battery operated devices, reduction of power consumption can enable extending battery life or reducing battery size.

If desired, the different functions discussed herein may be performed in a different order and/or concurrently with each other. Furthermore, if desired, one or more of the before-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which may be made without departing from the scope of the present invention as defined in the appended claims.

1. An apparatus, comprising:
a touch surface comprising one or more key tops configured to identify one or more keys to a user;
a key sensing circuitry configured to detect a key press of any one or more of the key tops;
a network of electromagnetic touch detectors configured to continually detect touching of the touch surface; and
an elastic layer between the key sensing circuitry and the key tops configured to relay pressing forces from the key tops to the key sensing circuitry.

2. The apparatus of claim 1, wherein:
the elastic layer comprises rubber.

3. The apparatus of claim 1, wherein:
the elastic layer comprises thermoplastic polyurethane.

4. The apparatus of claim 1, wherein:
the network of electromagnetic detectors is formed by selective activation plating.

5. The apparatus of claim 1, wherein:
the network of electromagnetic detectors is formed by super energy beam induced deposition.

6. The apparatus of claim 1, wherein:
the elastic layer comprises two opposite sides that are:
a first side facing towards the key sensing circuitry; and
a second side opposite to the first side;
the network of electromagnetic detectors is integrated to the second side of the elastic layer.

7. The apparatus of claim 1, further comprising a touch sensing layer comprising the network of electromagnetic detectors.

8. The apparatus of claim 7, wherein the touch sensing layer is plastic film.

9. The apparatus of claim 7, further comprising an exterior layer having a first side configured to form the touch surface; wherein:
the touch sensing layer is resiliently biased with the elastic layer against the exterior layer such that on pressing one of the one or more key tops so that movement of the touch sensing layer is greater with respect to the pressed key top.

10. The apparatus of claim 1, further comprising an exterior layer having a first side configured to form the touch surface; wherein
the exterior layer further comprises a second side opposite to the first side; and
the network of electromagnetic touch detectors is formed on the second side of the exterior layer.

11. The apparatus of claim 1, wherein:
the touch surface has a first region and a second region non-overlapping the first region; and
the key tops are solely comprised by the first region.

12. The apparatus of claim 1, wherein:
the electromagnetic touch detectors are capacitive touch sensors.

13. A device comprising:
a display; and
an apparatus comprising:
a touch surface comprising one or more key tops configured to identify one or more keys to a user;
a key sensing circuitry configured to detect a key press of any one or more of the key tops;
a network of electromagnetic touch detectors configured to continually detect touching of the touch surface; and
an elastic layer between the key sensing circuitry and the key tops configured to relay pressing forces from the key tops to the key sensing circuitry.

14. The device of claim 13, wherein:
the device is a mobile telephone.

15. The device of claim 13, wherein:
the device is a laptop computer and the apparatus is configured to form a touch pad.

16. A method comprising:
forming a touch surface comprising one or more key tops configured to identify one or more keys to a user;
forming a key sensing circuitry configured to detect a key press of any one or more of the key tops;
forming a network of electromagnetic touch detectors configured to continually detect touching of the touch surface; and
forming an elastic layer between the key sensing circuitry and the key tops configured to relay pressing forces from the key tops to the key sensing circuitry.

17. The method of claim 16, wherein the network of electromagnetic detectors is formed by selective activation plating.

18. The method of claim 16, wherein the network of electromagnetic detectors is formed by super energy beam induced deposition.

19. The method of claim 16, wherein network of electromagnetic detectors is formed onto a rear surface of an exterior layer that forms the key tops.

20. The method of claim 16, wherein network of electromagnetic detectors is formed onto the elastic layer.
